(19) United States
(12) Patent Application Publication
(10) Pub. No.: US 2012/0194534 A1
(43) Pub. Date: Aug. 2, 2012

(54) System and Method for Managing Cache Storage in Adaptive Video Streaming System

(75) Inventors: Steven A. Benno, Towaco, NJ (US); Jairo O. Esteban, Freehold, NJ (US)

(73) Assignee: ALCATEL-LUCENT USA INC., Murray Hill, NJ (US)

(21) Appl. No.: 13/019,613

(22) Filed: Feb. 2, 2011

(51) Int. Cl. G09G 5/36

(52) U.S. Cl. 345/557

(57) ABSTRACT

A plurality of encoded video segments that are stored in a cache memory and associated with every n^{th} video segment in a sequence of video segments of a video program is selected, where n is an integer. The selected encoded video segments are removed from the cache memory. Each video segment in the sequence may be associated with a respective plurality of encoded video segments encoded at different respective encoding rates.

### FIELD OF THE INVENTION

This invention relates generally to systems and methods for streaming data in a network, and more particularly to systems and methods for managing cache storage in an adaptive video streaming system.

### BACKGROUND

The use of video streaming is commonly used to deliver video data via the Internet and other networks. Typically, a video server divides a video program into segments, encodes each segment, and transmits the encoded segments via a network to a client device. The client device receives the encoded segments, decodes the segments, and presents the decoded segments in an appropriate sequence to produce a video presentation.

To facilitate the delivery of encoded video segments to a client device, selected encoded segments may be stored in a cache memory at a selected location in the network. When the client device requests an encoded segment associated with a video program, the cache may provide the requested encoded segment if it is stored in the cache (a condition known as a cache hit). If the encoded segment is not stored in the cache (a condition known as a cache miss), it may be necessary for the cache to obtain the encoded segment from the video server or from another source. A high number or a high frequency of cache misses may adversely affect the ability of the client device to produce a quality video presentation.

### SUMMARY OF THE INVENTION

In accordance with an embodiment of the invention, a method for removing video data stored in a cache is provided. A plurality of encoded video segments that are stored in a cache memory and associated with every n^{th} video segment in a sequence of video segments of a video program is selected, where n is an integer. The selected encoded video segments are removed from the cache memory. Each video segment in the sequence may be associated with a respective plurality of encoded video segments encoded at different respective encoding rates.

In one embodiment, encoded video segments associated with every second video segment in a sequence of video segments of a video program are selected.

The cache memory may comprise a random access memory in a cache device. The selected segments may be removed from the cache memory and stored in a storage in the cache device that is different from the cache memory. One or more second encoded video segments may be stored in the cache memory after removing the selected encoded video segments.

In another embodiment of the invention, a method for removing video data stored in a cache is provided. A plurality of encoded video segments that are stored in a cache memory and associated with n consecutive video segments in a sequence of video segments of a video program is selected, in accordance with a predetermined repeating pattern, where n is an integer not exceeding a predetermined limit. The selected encoded video segments are removed from the cache memory.

In another embodiment of the invention, a method for storing video data in a cache is provided. A plurality of encoded video segments associated with every n^{th} video segment in a sequence of video segments of a video program is selected, where n is an integer. The selected encoded video segments are transmitted to a cache memory, and stored in the cache memory.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system that may be used to stream video data in accordance with an embodiment of the invention;

FIG. 2 shows functional components of a client device in accordance with an embodiment of the invention;

FIG. 3 shows video segments of a video program and corresponding chunks in accordance with an embodiment of the invention;

FIG. 4 shows functional components of a cache in accordance with an embodiment of the invention;

FIG. 5 is a flowchart of a method for removing video data stored in a cache in accordance with an embodiment of the invention;

FIG. 6 shows the cache of FIG. 4 after selected chunks have been removed in accordance with an embodiment of the invention;

FIG. 7 is a flowchart for transmitting selected chunks to a cache for storage in accordance with an embodiment of the invention; and

FIG. 8 shows a computer which may be used to implement the invention.

### DETAILED DESCRIPTION

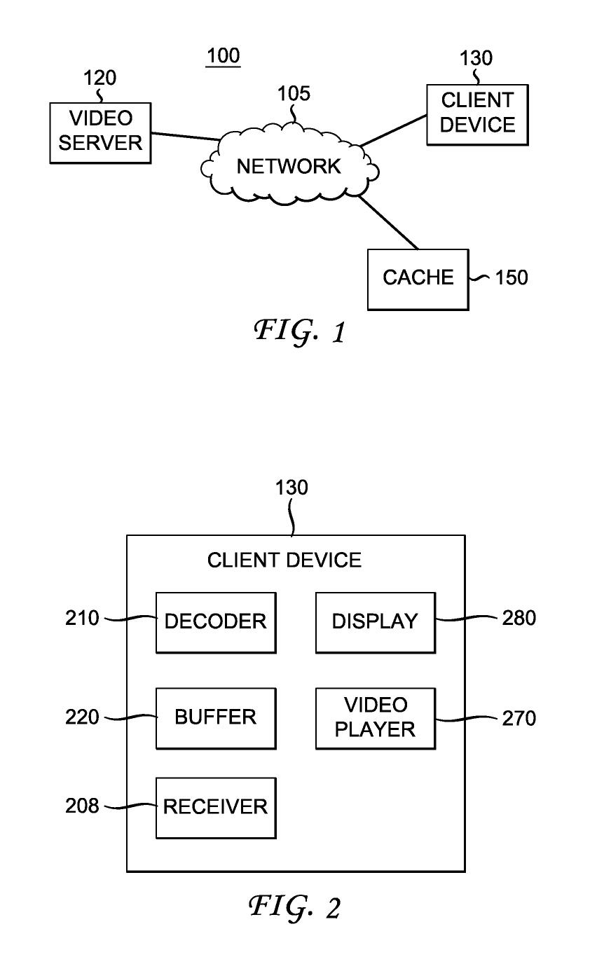

FIG. 1 shows a communication system 100 that may be used to stream video data in accordance with an embodiment of the invention. Communication system 100 comprises a network 105, a video server 120, a client device 130, and a cache 150.

In the exemplary embodiment of FIG. 1, network 105 is the Internet. In other embodiments, network 105 may comprise one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 105 may comprise a combination of different types of networks.

In the exemplary embodiment of FIG. 1, one video server 120 is shown; however, communication system 100 may comprise any number of video servers. Similarly, one client device 130 and one cache 150 are shown in FIG. 1; however, communication system 100 may comprise any number of clients and any number of caches.

Video server 120 streams video data via network 105 to client device 130. Techniques for video streaming are known. Video server 120 may encode video data before transmitting the data to client device 130. Video server 120 may store video data in a storage device, for example. Alternatively, video server 120 may receive video data from other sources.

Client device 130 receives video data via network 105, decodes the data (if necessary), and presents the resulting video program. The video program may be shown on a display device, for example.

FIG. 2 shows functional components of client device 130 in accordance with an embodiment of the invention. Client device 130 comprises a receiver 208, a decoder 210, a buffer 220, a video player 270, and a display 280. Encoded video data is received via network 105 by receiver 208 and stored in buffer 220. Decoder 210 decodes the encoded video data. Video player 270 plays back decoded video data to produce a video presentation. A video program may be presented on display 280. Client device 130 may comprise other components in addition to those shown in FIG. 2.

In one embodiment, buffer 220 has a specified size defined as a time period T; when full, buffer 220 stores an amount of encoded video data corresponding to T seconds of a video program. For example, a buffer may be described as having a capacity to hold fifteen seconds of video data. Therefore, the size of buffer 220, measured in bytes, may vary.

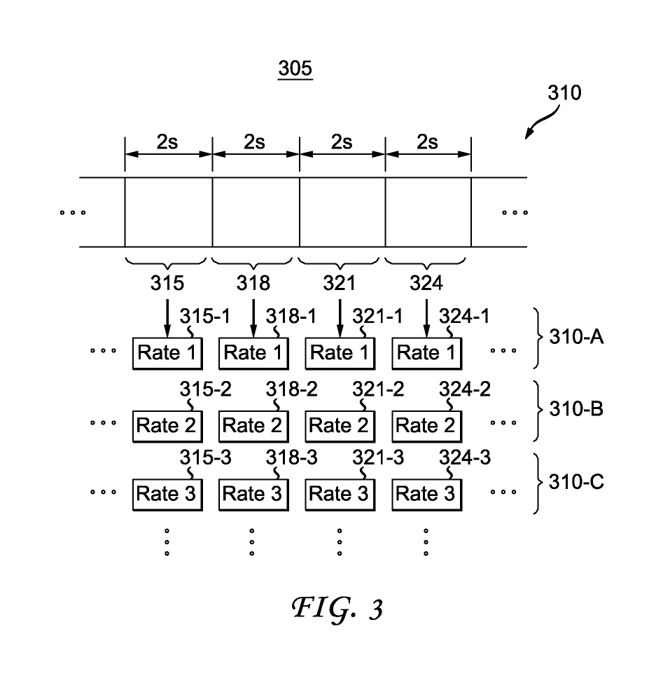

Video server 120 divides a video program into a sequence of video segments, and encodes each segment in accordance with a selected delivery format. In one embodiment, each segment may contain from two to ten seconds of video data. FIG. 3 shows a video program 305 which has been divided into a sequence 310 of video segments in accordance with an embodiment of the invention. Sequence 310 comprises a plurality of two-second video segments, including segments 315, 318, 321, and 324.

In accordance with a technique known as HyperText Transfer Protocol (HTTP) adaptive streaming, some or all of the video segments in sequence 310 are encoded multiple times at different encoding rates, resulting in a plurality of encoded video segments (referred to as “chunks”) for each original video segment in sequence 310. Referring to FIG. 3, video segment 315 is encoded at Rate 1, resulting in chunk 315-1, at Rate 2, resulting in chunk 315-2, and at Rate 3, resulting in chunk 315-3. Rate 1, Rate 2, and Rate 3 are different. Similarly, segment 318 is encoded at Rate 1, Rate 2, and Rate 3, resulting in chunks 318-1, 318-2, and 318-3; segment 321 is encoded at Rate 1, Rate 2, and Rate 3, resulting in chunks 321-1, 321-2, and 321-3; and segment 324 is encoded at Rate 1, Rate 2, and Rate 3, resulting in chunks 324-1, 324-2, and 324-3. Other video segments in sequence 310 may also be encoded in this manner, resulting in multiple chunks for each segment. Typically, for a given video segment, a chunk that is encoded at a higher encoding rate is larger, i.e., contains more bits of data, than a chunk encoded at a lower encoding rate. Systems and methods for performing HTTP adaptive streaming of video data are known.

In FIG. 3, three sequences of chunks are shown. Each sequence is associated with an encoding rate (the “sequence rate”). Sequence 310-A is associated with Rate 1 and comprises chunks 315-1, 318-1, 321-1, and 324-1. Similarly, sequence 310-B is associated with Rate 2 and comprises chunks 315-2, 318-2, 321-2, and 324-2, and sequence 310-C is associated with Rate 3 and comprises chunks 315-3, 318-3, 321-3, and 324-3. However, each video segment in a sequence of video segments (such as sequence 310) may be encoded at more than three different encoding rates, or at fewer than three different encoding rates. In one embodiment, each video segment is encoded at between six and twelve different encoding rates between 300 Kbps and 2.4 Mbps.

Video server 120 may generate a manifest file (not shown) identifying video segments associated with a respective video program, the corresponding chunks, and the encoding rates of the various chunks. The chunks, and the associated manifest file, may be stored on video server 120.

Prior to downloading a desired video program, client device 130 may download from video server 120, or otherwise access, the manifest file containing information concerning the desired video program, and identify the sequence of video segments associated with the video program. Supposing, for example, that client device 130 needs to play video program 305, client device 130 may access the relevant manifest file and determine that video program 305 comprises sequence 310 and is associated with segments 315, 318, 321, 324, etc. Client device 130 may select a particular video segment and transmits to video server 120 a request for a corresponding chunk. Video server 120 transmits the requested chunks to client 120. As chunks are received by client device 130, client device 130 decodes the chunks and plays back the decoded video segments in an appropriate sequence to produce a video presentation.

For a particular video segment, client device 130 determines which chunk to request from among the corresponding chunks of different quality levels, based on a rate determination algorithm that considers various factors. In one embodiment, client device 130 selects a chunk that offers the highest sustainable quality level for current network conditions. For example, while receiving chunks corresponding to a sequence of video segments, client device 130 may periodically determine current available bandwidth based on the delay between transmission of a request for a respective chunk and receipt of the requested chunk, and determine a quality level of a subsequent chunk to be requested based on the current bandwidth. The rate determination algorithm may also consider the need to keep buffer 220 sufficiently full to avoid pauses, stops, and stutters in the presentation of the video stream.

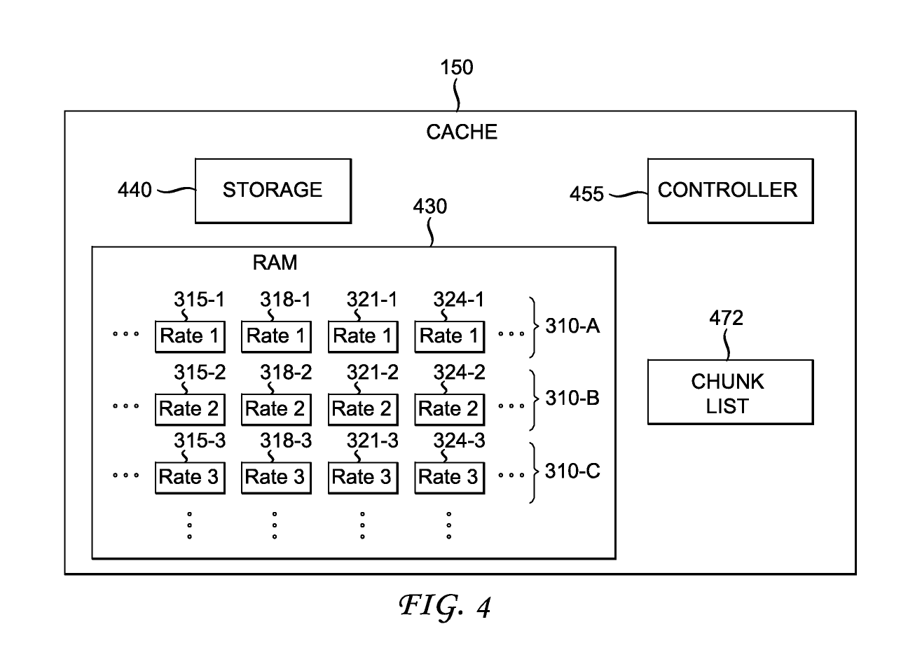

To facilitate the delivery of chunks associated with a video program, one or more chunks may be stored in cache 150 and accessed by client device 130 as needed. Cache 150 can ordinarily provide data to client device 130 more quickly than can video server 120. For example, cache 150 may be closer to client device 130 than video server 120. FIG. 4 shows functional components of cache 150 in accordance with an embodiment of the invention. Cache 150 comprises a controller 455, a random access memory (RAM) 430, a storage 440, and a chunk list 472. RAM 430 comprises a relatively high-speed memory device. Storage 440 comprises a memory device such as one or more disk drives. When a video program is being delivered to client device 130, controller 455 may receive chunks of video data from video server 120 and store the chunks in RAM 430 and/or in storage 440 based on one or more predetermined policies. For example, in the embodiment of FIG. 4, chunks 315-1, 315-2, 315-3, 318-1, 318-2, 318-3, 321-1, 321-2, 321-3, 324-1, 324-2, and 324-3 (associated with video program 305) are stored in RAM 430. In response to a request from client device 130, controller 455 may retrieve a chunk from RAM 430 or from storage 440 and transmits the chunk to client device 130. Chunk list 472 stores information identifying chunks that are stored in cache 150, video segments corresponding to the respective chunks, the chunks' encoding rates, the memory locations of the respective chunks, etc. While two cache memories (RAM 430 and storage 440) are shown in FIG. 4, cache 150 may comprise any number of cache memories, storage devices, etc.

In accordance with an embodiment of the invention, when client device 130 requests from video server 120 a chunk associated with a particular video program, a request for the chunk may first be made to cache 150. For example, video server 120 may transmit a request to cache 150 identifying the requested chunk and client device 130. In response to the request, controller 455 may determine the presence or absence in cache 150 of the requested chunk, for example, by consulting chunk list 472. If the requested chunk is stored in cache 150 (a condition referred to as a cache hit), cache 150 may transmit the requested chunk to client device 130.

If the requested chunk is not stored in cache 150 (a condition referred to as a cache miss), cache 150 may obtain the requested chunk from video server 120, and then provide the requested chunk to client device 130. After obtaining the requested chunk from video server 120, cache 150 may also store the chunk. In order to store a new chunk, it may be necessary for controller 455 to remove, or evict, one or more chunks currently stored in RAM 430 or in storage 440. Controller 455 may select chunks for eviction based on a predetermined replacement algorithm. Existing replacement algorithms select chunks for replacement based on parameters including frequency of chunk utilization, recency of chunk utilization, size of chunks, etc.

When a cache miss renders it necessary for a client device to obtain a desired chunk from the video server or from another source, the client device's ability to produce a high quality video presentation may be adversely affected. Specifically, when the time required to download a desired chunk exceeds the associated playback time of the chunk, the delay may “drain” the client device's buffer. When a client device's buffer becomes low or empty, the client device's rate determination algorithm may determine that it is necessary to select chunks of lower quality, compromising the device's ability to produce a high quality video presentation.

In particular, a high number or high frequency of cache misses can adversely affect the performance of a client device's rate determination algorithm and reduce the quality of a video presentation produced by the client device. For example, repeated, or frequent, cache misses can drain the client device's buffer, causing a reduction in the quality level of the video presentation, or undesirable oscillations between quality levels in the video presentation.

Existing replacement algorithms used to manage video data stored in caches fail to consider the effect of cache hits and misses on the rate determination algorithms used by client devices in an HTTP adaptive video streaming system. Some traditional cache replacement algorithms may even increase the likelihood of repeated cache misses, causing undesirable effects in the clients' playback of a video program.

In accordance with an embodiment of the invention, a replacement algorithm is used which considers the effects of data eviction on a client device's rate determination algorithm. In particular, a replacement algorithm is provided which reduces the likelihood of repeated cache misses in an HTTP adaptive streaming video system, in order to avoid excessive draining of the client device's buffer, thereby enabling the client to provide a video stream of consistent quality.

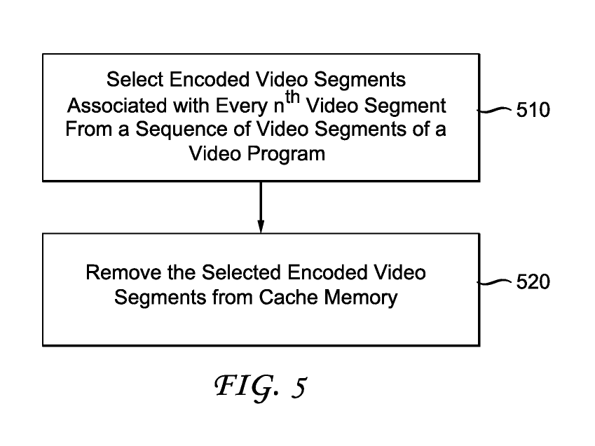

FIG. 5 is a flowchart of a method for removing video data stored in a cache in accordance with an embodiment of the invention. In an illustrative example, suppose that controller 455 receives new data to be stored in RAM 430, and determines that some data currently stored in RAM 430 must be evicted. Suppose further that controller 455 determines that a portion of the data chunks associated with video program 305 must be evicted from RAM 430.

At step 510, chunks associated with every n^{th} video segment from a sequence of video segments of a video program are selected, where n is an integer. To facilitate the selection of specific chunks to be evicted, controller 455 may access chunk list 472 and/or the manifest file maintained by video server 120, and identify video segment sequence 310 associated with video program 305, which includes segments 315, 318, 321, 324. In the present example, n=2 and controller 455 therefore selects chunks associated with every second video segment in sequence 310. Thus, controller 455 selects chunks 318-1, 318-2, and 318-3, associated with segment 318, and chunks 324-1, 324-2, and 324-3, associated with segment 324.

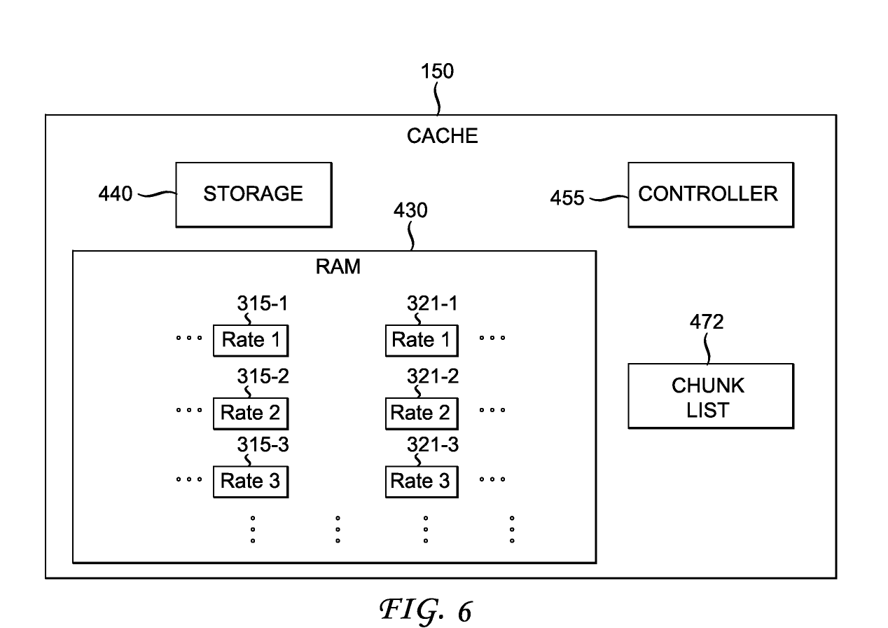

At step 520, the selected chunks are removed from the cache memory. In the present example, the cache memory is RAM 430. Thus, controller 455 removes chunks 318-1, 318-2, and 318-3, associated with segment 318, and chunks 324-1, 324-2, and 324-3, associated with segment 324, from RAM 430. FIG. 6 shows cache 150 after the selected chunks have been evicted in accordance with an embodiment of the invention. Only chunks 315-1, 315-2, 315-3, and 321-1, 321-2, and 321-3 remain in RAM 430.

In an alternative embodiment, chunks may be selected based on a predetermined irregular pattern. For example, controller 455 may identify groups of ten consecutive video segments in a sequence of video segments, select the 1^{st}, 7^{th} and 9^{th} video segments from every group, and evict chunks associated with the selected segments.

In another embodiment, controller 455 selects, based on a predetermined pattern, groups of consecutive video segments in a sequence, such that no more than a predetermined number of consecutive segments are selected. In one example, no more than three consecutive video segments are selected from a defined group of segments. For example, controller 455 may identify groups of ten consecutive video segments in a sequence, select the 1^{st}, 2^{nd}, and 3^{rd} video segments from every group, and evict chunks associated with the selected segments. In one embodiment, chunks are selected in this manner from chunks that are older (e.g., chunks that have been stored in cache 150 longer than other chunks) or less popular (e.g. chunks that are not accessed as frequently as other chunks).

In other embodiments, video segments may be selected in accordance with any predetermined pattern selected to minimize the occurrence of cache misses that will cause excessive draining of a client device's buffer.

In one embodiment, evicted chunks are permanently removed from cache 150. In another embodiment, evicted chunks are removed from RAM 430 and stored in storage 440, which comprises a memory device that is slower than RAM 430.

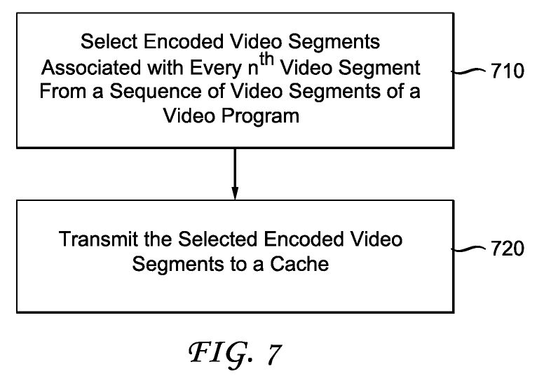

In another embodiment, chunks are selectively stored in cache 150 after a video program has been encoded and before any chunk is requested by a client device. In an exemplary embodiment, selected chunks associated with video program 305 are pre-stored in cache 150 after video program 305 is encoded and before any chunk is requested by client device 130. FIG. 7 is a flowchart for selecting and transmitting chunks to a cache for storage, in accordance with an embodiment of the invention. At step 710, chunks associated with every n^{th} video segment from sequence 310 are selected, in the manner described above. For example, video server 120 may select chunks associated with every second video segment in sequence 310. At step 720, video server 120 transmits the selected chunks to cache 150. Cache 150 receives the selected chunks and stores the chunks in RAM 430. In this manner, the selected chunks are pre-stored in cache 150 to facilitate the provision of video data to client device 130 when client device 130 subsequently requests the video data.

In an alternative embodiment, chunks may be selected based on a predetermined irregular pattern, and pre-stored in cache 150. For example, video server 120 may identify groups of ten consecutive video segments in a sequence of video segments, select the 1^{st}, 7^{th} and 9^{th} video segments from every group, and transit to cache 150 chunks associated with the selected segments. The chunks are then stored in cache 150.

In another embodiment, video server 120 selects, based on a predetermined pattern, groups of consecutive video segments in a sequence, such that no more than a predetermined number of consecutive segments are selected. In one example, no more than three consecutive video segments are selected from a defined group of segments. For example, video server 120 may identify groups of ten consecutive video segments in a sequence, select the 1^{st}, 2^{nd}, and 3^{rd} video segments from every group, and transmit to cache 150 chunks associated with the selected segments. The chunks are then stored in cache 150.

While the systems and methods described herein are discussed in the context of HTTP adaptive video streaming, this exemplary embodiment is not intended to be limiting. The systems and methods described herein may be used to stream other types of data.

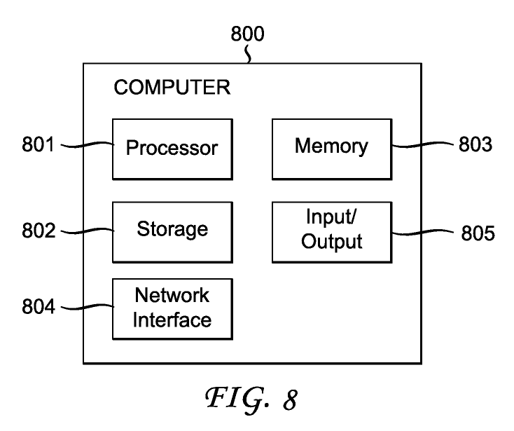

The above-described systems and methods can be implemented on one or more computers using well-known computer processors, memory units, storage devices, computer software, and other components. A high-level block diagram of such a computer is illustrated in FIG. 8. Computer 800 contains a processor 801, which controls the overall operation of computer 800 by executing computer program instructions that define such operations. The computer program instructions may be stored in a storage device 802, or other computer readable medium (e.g., magnetic disk, CD ROM, etc.), and loaded into memory 803 when execution of the computer program instructions is desired. Thus, the method steps of FIGS. 5 and/or 7 can be defined by the computer program instructions stored in the memory 803 and/or storage 802 and controlled by the processor 801 executing the computer program instructions. For example, the computer program instructions can be implemented as computer executable code programmed by one skilled in the art to perform an algorithm defined by the method steps of FIGS. 5 and/or 7. Accordingly, by executing the computer program instructions, the processor 801 executes an algorithm defined by the method steps of FIGS. 5 and/or 7. Computer 800 also includes one or more network interfaces 804 for communicating with other devices via a network. Computer 800 also includes one or more input/output devices 805 that enable user interaction with computer 800 (e.g., display, keyboard, mouse, speakers, buttons, etc.). One skilled in the art will recognize that an implementation of an actual computer could contain other components as well, and that FIG. 8 is a high level representation of some of the components of such a computer for illustrative purposes. Computer 800 may also include peripherals, such as a printer, scanner, display screen, etc. For example, computer 800 may be a server computer, a mainframe computer, a personal computer, a laptop computer, a television, a cell phone, a multimedia player, etc. Other processing devices may be used.

Any or all of the systems and apparatus discussed herein, including video server 120, client device 130, and cache 150, and components thereof, including controller 455, storage 440, RAM 430, and chunk list 472, may be implemented using a computer such as computer 800.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for removing video data stored in a cache, the method comprising:
selecting a plurality of encoded video segments that are stored in a cache memory and associated with every n^{th} video segment in a sequence of video segments of a video program, where n is an integer; and
removing the plurality of selected encoded video segments from the cache memory.

2. The method of claim 1, wherein each video segment in the sequence is associated with a respective plurality of encoded video segments encoded at different respective encoding rates.

3. The method of claim 1, wherein the step of selecting a plurality of encoded video segments comprises selecting encoded video segments that are stored in a cache memory and associated with every second video segment in a sequence of video segments of a video program.

4. The method of claim 1, wherein the cache memory comprises a random access memory in a cache device, the method further comprising:
storing the removed segments in a storage in the cache device that is different from the cache memory.

5. The method of claim 1, further comprising:
storing one or more second encoded video segments in the cache memory after removing the selected encoded video segments.

6. An apparatus for removing video data stored in a cache, the apparatus comprising:
means for selecting a plurality of encoded video segments that are stored in a cache memory and associated with every n^{th} video segment in a sequence of video segments of a video program, where n is an integer; and
means for removing the selected encoded video segments from the cache memory.

7. The apparatus of claim 6, wherein each video segment in the sequence is associated with a respective plurality of encoded video segments encoded at different respective encoding rates.

8. The apparatus of claim 6, wherein the means for selecting a plurality of encoded video segments comprises means for selecting encoded video segments stored in a cache memory associated with every 2^{nd} video segment in a sequence of video segments of a video program.

9. The apparatus of claim 6, wherein the cache memory comprises a random access memory in a cache device, the apparatus further comprising:
means for storing the removed segments in a storage in the cache device that is different from the cache memory.

10. The apparatus of claim 6, further comprising:
means for storing one or more second encoded video segments in the cache memory after removing the selected encoded video segments.

11. A non-transitory computer readable medium having program instructions stored thereon, the instructions capable of execution by a processor and defining the steps of:
selecting a plurality of encoded video segments that are stored in a cache memory and associated with every n^{th} video segment in a sequence of video segments of a video program, where n is an integer; and
removing the selected encoded video segments from the cache memory.

12. The non-transitory computer readable medium of claim 11, wherein each video segment in the sequence is associated with a respective plurality of encoded video segments encoded at different respective encoding rates.

13. The non-transitory computer readable medium of claim 11, wherein the instructions defining the step of selecting a plurality of encoded video segments further comprise instructions defining the step of selecting encoded video segments stored in a cache memory associated with every 2^{nd} video segment in a sequence of video segments of a video program.

14. The non-transitory computer readable medium of claim 11, wherein the cache memory comprises a random access memory in a cache device, wherein the instructions further comprise instructions defining the step of:
storing the removed segments in a storage in the cache device that is different from the cache memory.

15. The non-transitory computer readable medium of claim 11, further comprising instructions defining the step of:
storing one or more second encoded video segments in the cache memory after removing the selected encoded video segments.

16. A method for removing video data stored in a cache, the method comprising:
selecting a plurality of encoded video segments that are stored in a cache memory and associated with n consecutive video segments in a sequence of video segments of a video program, in accordance with a predetermined repeating pattern, where n is an integer not exceeding a predetermined limit; and
removing the plurality of selected encoded video segments from the cache memory.

17. The method of claim 16, wherein each video segment in the sequence is associated with a respective plurality of encoded video segments encoded at different respective encoding rates.

18. The method of claim 16, wherein the cache memory comprises a random access memory in a cache device, the method further comprising:
storing the removed segments in a storage in the cache device that is different from the cache memory.

19. The method of claim 16, further comprising:
storing one or more second encoded video segments in the cache memory after removing the selected encoded video segments.

20. A method for storing video data in a cache, the method comprising:
selecting a plurality of encoded video segments associated with every n^{th} video segment in a sequence of video segments of a video program, where n is an integer; and
transmitting the plurality of selected encoded video segments to a cache memory.

21. The method of claim 20, wherein each video segment in the sequence is associated with a respective plurality of encoded video segments encoded at different respective encoding rates.

22. The method of claim 20, wherein the step of selecting a plurality of encoded video segments comprises selecting encoded video segments associated with every second video segment in a sequence of video segments of a video program.
